(19) United States
(12) Patent Application Publication
(10) Pub. No.: US 2026/0338958 A1
(43) Pub. Date: Oct. 29, 2026

(54) CONTROLLER, OPTICAL SENSOR, CONTROL METHOD, NON-TRANSITORY COMPUTER READABLE STORAGE MEDIUM

(71) Applicant: DENSO CORPORATION, Kariya-city (JP)

(72) Inventors: Shingo MASAKI, Kariya-city (JP); Kazumasa NAKAJIMA, Kariya-city (JP)

(21) Appl. No.: 19/703,576

(22) Filed: Jun. 10, 2026

Related U.S. Application Data
(63) Continuation of application No. PCT/JP2024/043168, filed on Dec. 6, 2024.

(30) Foreign Application Priority Data
Jan. 30, 2024 (JP) 2024-012279

(51) Int. Cl. G01S 17/931; G01S 7/48; G01S 7/481; G01S 7/487

(52) U.S. Cl. CPC G01S 17/931; G01S 7/4802; G01S 7/4816; G01S 7/4817; G01S 7/4873; G01S 7/4876

(57) ABSTRACT

A controller controls an optical sensor that emits beams into an external environment and, for each detection cycle, receives reflected echoes from an object and outputs detection data. For each detection cycle and detection pixel, the controller acquires a received light intensity of each reflected echo and associates the intensity with a detection distance based on a reception timing. The controller monitors a noise ratio for each detection cycle and generates detection data indicating a rainfall condition based on the noise ratio. The noise ratio equals a number of noise pixels divided by a corrected number of pixels. Noise pixels correspond to echoes identified as reflections from falling raindrops. The corrected number of pixels equals a total number of pixels detecting reflected echoes minus a number of valid pixels, where valid pixels correspond to echoes from the object.

### CROSS REFERENCE TO RELATED APPLICATIONS

The present application is a continuation application of International Patent Application No. PCT/JP2024/043168 filed on Dec. 6, 2024, which designated the U.S. and claims the benefit of priority from Japanese Patent Application No. 2024-012279, filed on Jan. 30, 2024. The entire disclosures of all of the above applications are incorporated herein by reference.

### TECHNICAL FIELD

The present disclosure relates to a control technique for an optical sensor.

### BACKGROUND

An optical sensor is controlled to receive reflected echoes from a target with respect to a light beam projected to external environment and output detection data.

### SUMMARY

According to at least one embodiment, a controller includes at least one of (i) a circuit and (ii) a processor with a memory storing computer program code executable by the processor. The at least one of the circuit and the processor causes the controller to control an optical sensor. For each detection cycle, the optical sensor receives reflected echoes from an object in response to projected beams emitted to an external environment. For each detection cycle, the optical sensor outputs detection data. For each detection cycle and for each detection pixel of the detection data, the controller acquires a received light intensity of each reflected echo received by the optical sensor and associated with a detection distance to the object. The detection distance corresponds to a reception timing of the reflected echo by the optical sensor. The controller may monitor a noise ratio for each detection cycle. The controller generates, based on the noise ratio, the detection data indicating a rainfall condition in the external environment. The noise ratio is a ratio of a number of noise pixels to a corrected number of pixels. The number of noise pixels is a number of detection pixels that have detected noise echoes identified as reflected echoes from raindrops falling in the external environment. The corrected number of pixels is obtained by subtracting a number of valid pixels from a total number of detection pixels that have detected the reflected echoes. The number of valid pixels is a number of detection pixels that have detected valid echoes identified as reflected echoes from the object.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a cross-sectional view illustrating an overall configuration of an optical sensor according to a first embodiment.

FIG. 2 is a block diagram illustrating a functional configuration of the optical sensor according to the first embodiment.

FIG. 3 is a schematic diagram illustrating a light source unit according to the first embodiment.

FIG. 4 is a schematic diagram illustrating a light receiving unit according to the first embodiment.

FIG. 5 is a schematic diagram for explaining detection data according to the first embodiment.

FIG. 6 is a flowchart illustrating a control flow according to the first embodiment.

FIG. 7 is a graph for explaining the control flow according to the first embodiment.

FIG. 8 is a graph for explaining the control flow according to the first embodiment.

FIG. 9 is a graph for explaining the control flow according to the first embodiment.

FIG. 10 is a graph for explaining the control flow according to the first embodiment.

FIG. 11 is a schematic diagram for explaining the control flow according to the first embodiment.

FIG. 12 is a flowchart illustrating a control flow according to a second embodiment.

FIG. 13 is a schematic diagram for explaining detection data according to the second embodiment.

FIG. 14 is a schematic diagram for explaining a relationship between the detection data and a detection field of view according to the second embodiment.

FIG. 15 is a flowchart illustrating a control flow according to a third embodiment.

FIG. 16 is a flowchart illustrating a control subroutine according to the third embodiment.

FIG. 17 is a flowchart illustrating a control flow according to a fourth embodiment.

FIG. 18 is a graph for explaining the control flow according to the fourth embodiment.

### DETAILED DESCRIPTION

To begin with, examples of relevant techniques will be described.

An optical sensor is controlled to receive reflected echoes from a target with respect to a light beam projected to external environment and output detection data. An optical sensor according to a comparative example has a technique for detecting rainfall such as a LiDAR (Light Detection and Ranging).

The optical sensor can determine whether autonomous driving is possible based on the rainfall detection results obtained by effectively utilizing LiDAR, which detects distance, but the optical sensor does not output the detection results themselves as an accurate indicator of the rainfall condition.

In contrast to the comparative example, according to a controller of the present disclosure, an optical sensor, which detects distance, can be used to accurate output of rainfall conditions.

Hereinafter, the technical means of the present disclosure for solving the above problems will be described.

According to one aspect of the present disclosure, a controller includes at least one of (i) a circuit and (ii) a processor with a memory storing computer program code executable by the processor. The at least one of the circuit and the processor causes the controller to control an optical sensor. For each detection cycle, the optical sensor receives reflected echoes from an object in response to projected beams emitted to an external environment. For each detection cycle, the optical sensor outputs detection data. For each detection cycle and for each detection pixel of the detection data, the controller acquires a received light intensity of each reflected echo received by the optical sensor and associated with a detection distance to the object. The detection distance corresponds to a reception timing of the reflected echo by the optical sensor. The controller monitors a noise ratio for each detection cycle. The controller generates, based on the noise ratio, the detection data indicating a rainfall condition in the external environment. The noise ratio is a ratio of a number of noise pixels to a corrected number of pixels. The number of noise pixels is a number of detection pixels that have detected noise echoes identified as reflected echoes from raindrops falling in the external environment. The corrected number of pixels is obtained by subtracting a number of valid pixels from a total number of detection pixels that have detected the reflected echoes. The number of valid pixels is a number of detection pixels that have detected valid echoes identified as reflected echoes from the object.

According to this configuration, the received intensity of each of the reflected echoes by the optical sensor, corresponding to the detection distance to the target object based on the reception timing of the reflected echo, is acquired for each detection cycle in association with each detection pixel of the detection data. Therefore, attention is given to the effective pixel count, which is the number of detection pixels that have detected valid echoes identified as reflected echoes from the target object, with respect to the corrected pixel count obtained by subtracting a correction value from the total number of detection pixels.

More specifically, the noise ratio is monitored in each detection cycle. Accordingly, it is possible to generate detection data that notifies the rainfall condition based on the noise ratio, which has been corrected for the influence of undetected noise echoes from raindrops due to the detection of valid echoes from the target object. Therefore, the optical sensor that detects the distance can be effectively utilized for accurate output of the rainfall condition based on the detection data.

The following will describe embodiments of the present disclosure with reference to the drawings. In the respective embodiments, corresponding components are denoted by the same reference numerals, and redundant descriptions may be omitted. Further, in cases where only a part of a configuration is described in each embodiment, the other parts of the configuration may be applied using the configurations described in the preceding embodiments. Further, not only the combinations of the configurations explicitly shown in the description of the respective embodiments, but also the configurations of the multiple embodiments can be partially combined together even if the configurations are not explicitly shown if there is no contradiction in the combination in particular.

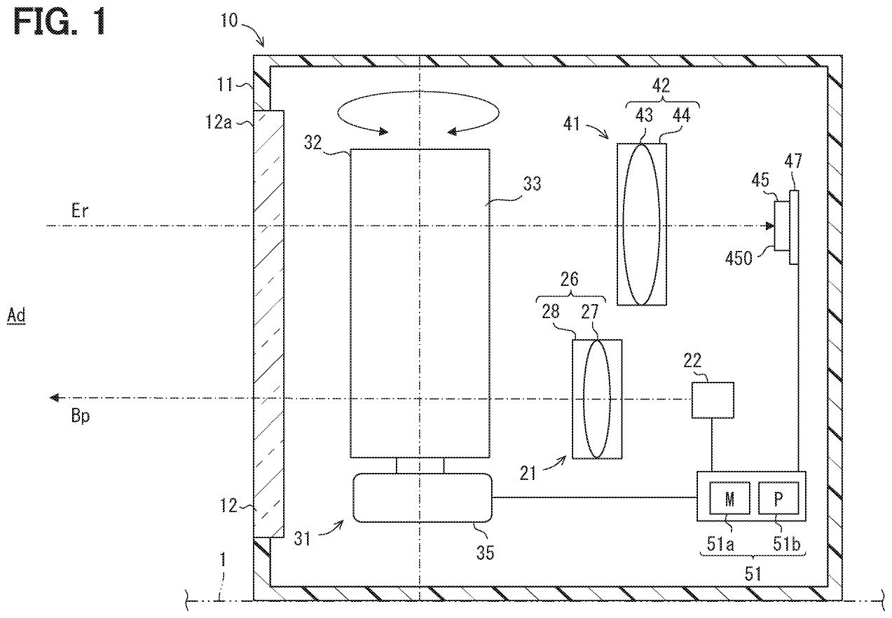

As shown in FIG. 1, an optical sensor 10 according to a first embodiment of the present disclosure is configured to be mountable on a moving object 1 and is a LiDAR (Light Detection and Ranging/Laser Imaging Detection and Ranging) for optically detecting an external environment of the moving object 1. The moving object 1 to which the optical sensor 10 is to be placed is a vehicle, such as a car, which is capable of at least one of the following types of operation: manual operation, automated driving, and remote operation. In the following description, unless otherwise specified, the directions of front, rear, upper, lower, left, and right are defined based on the moving object 1 on a horizontal plane. In the following description, a horizontal direction and a vertical direction mean, respectively, parallel and perpendicular directions to the horizontal plane in the moving object 1 on the horizontal plane. In FIG. 1, a portion on a left side of a dash-dot-dash line along the vertical direction (a cover panel 12 side described later) actually illustrates a cross-section perpendicular to a portion on a right side of the dash-dot-dash line (unit 21 and 41 described later).

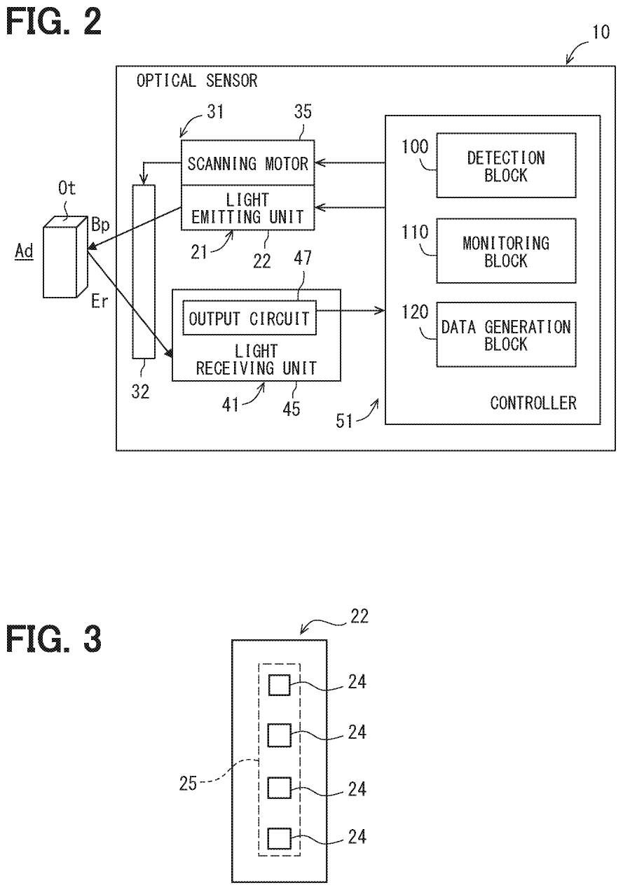

The optical sensor 10 is disposed in at least one of a front portion, left and right side portions, a rear portion, and an upper roof of the moving object 1. As shown in FIGS. 1 and 2, the optical sensor 10 emits a projected beam Bp toward a detection area Ad, which corresponds to an area in the external environment determined by the installation position on the moving object 1 and the detection field of view. The optical sensor 10 detects, as a reflected echo Er, a reflected beam that returns after the projected beam Bp is reflected by a target object Ot in the detection area Ad in the external environment. In this manner, light in a near-infrared region, which is difficult for humans to visually perceive, is selected for the projected beam Bp that serves as the reflected echo Er.

The optical sensor 10 detects a target object Ot present in the detection area Ad of the external environment by receiving the reflected echo Er that is reflected from the projected beam Bp. Here, detection of the target object Ot refers to sensing multiple types of information, including at least the distance and intensity, such as a distance from the optical sensor 10 to the target object Ot, the intensity of the reflected echo Er reflected from the target object Ot, and a direction in which the target object Ot is present.

In the optical sensor 10 applied to the moving object 1, typical detection targets for the target object Ot may include at least one type of moving object, such as a pedestrian, cyclist, animal other than humans, or another vehicle. In the optical sensor 10 applied to the moving object 1, typical detection targets for the target object Ot may include at least one type of stationary object, such as a guardrail, road sign, roadside structure, or fallen object on the road.

As shown in FIG. 1, the optical sensor 10 includes a housing 11, a light emitting unit 21, a scanning unit 31, a light receiving unit 41, and a controller 51. The housing 11 having a light shielding characteristic is formed in a box shape from, for example, metal or resin. The housing 11 accommodates the light emitting unit 21, the scanning unit 31, and the light receiving unit 41 inside. An opening penetrating through an interior and an exterior in the housing 11 is closed by a cover panel 12. The cover panel 12 having a translucent characteristic is formed of resin or glass, for example, and partitions the interior and the exterior of the housing 11. As a result, an outer surface of the cover panel 12 forms the detection surface 12a that is exposed to the external environment in the optical sensor 10.

As shown in FIGS. 1 and 2, the light emitting unit 21 includes a light source unit 22 and a projection lens unit 26. As shown in FIG. 3, the light source unit 22 is constructed by light source elements 24 mounted on a substrate in an arrayed manner. Each light source element 24 is a laser diode arranged in a single row (see the example in FIG. 3) or in multiple rows (not shown) along the vertical direction. Each light source element 24 generates laser light in pulses, which constitutes a part of the projected beam Bp, in accordance with control signals from the controller 51. Each one of the light source elements 24 may be an edge-emitter laser or a vertical cavity surface emitting laser (VCSEL).

The light source unit 22 forms, on one side of the substrate, a light source window 25 that is defined pseudo-rectangularly, being elongated along the vertical direction and shorter along the horizontal direction. The light source window 25 is configured as an aggregate of laser emission apertures of the respective light source elements 24. The laser light emitted from the laser emission apertures of each light source element 24 is projected from the light source window 25 as the projected beam Bp, which is pseudo-formed as an elongated line beam along the vertical direction, at least within the detection area Ad in the external environment.

As shown in FIG. 1, the projection lens unit 26 is constructed with at least one projector lens 27 held in a lens barrel 28. At least one projector lens 27 is mainly made of a light-transmitting base material such as resin or glass, and is formed into a lens shape according to an optical function to be demonstrated. The projection lens 27 exerts at least one type of optical action, such as focusing, collimating, and shaping, on the projected beam Bp from the light source unit 22. The projector lens 27 is positioned in the lens barrel 261 with a light-shielding property, formed, for example, of metal or resin. The projection lens unit 26 in such a configuration is aligned with the light source unit 22 to form a projection optical axis Op that guides the projected beam Bp toward the scanner unit 31.

As shown in FIGS. 1 and 2, the scanning unit 31 includes a scanning mirror 32 and a scanning motor 35. The scanning mirror 32 is constructed in a plate shape, with a reflective film deposited on a reflective surface 33, which is one side of the substrate. The scanning mirror 32 is supported by the housing 11 so as to be rotatable around a rotational center axis extending in the vertical direction. The scanning mirror 32 swings within a driving range limited by a mechanical or electrical stopper.

The scanning motor 35 is, for example, a voice coil motor, a DC motor with brushes, a stepping motor, or the like. An output shaft of the scanning motor 35 is coupled to the scanning mirror 32 directly or indirectly via a drive mechanism such as a speed reducer. The scanning motor 35 is held by the housing 11 in a manner capable of driving the scanning mirror 32 in a rotatable together with the output shaft. The scanning motor 35 drives the scanning mirror 32 to rotate, i.e., to swing, within the driving range that is limited, according to a control signal from the controller 51.

The scanning mirror 32 scans the detection area Ad according to the rotational angle of the scanning motor 35 by reflecting the projected beam Bp, which is incident from the light emitting unit 21, off the reflective surface 33 and projecting it through the cover panel 12 into the detection area Ad. At this time, the scanning of the detection area Ad by the projected beam Bp is, in the present embodiment, substantially limited to horizontal scanning in accordance with the rotational drive of the scanning mirror 32.

The scanning mirror 32 reflects the reflected echo Er, which is incident from the target Ot in the detection area Ad through the cover panel 12, toward the light receiving unit 41 in accordance with the rotational angle of the scanning motor 35, via the reflective surface 33. Speeds of the projected beam Bp and the reflected echo Er are sufficiently large relative to the rotational speed of the scanning mirror 32. The reflected echo Er is then guided to the light receiving unit 41 in a retrograde direction from the projected beam Bp by reflection action from the scanning mirror 32, whose angle to the projected beam Bp can be mimicked to be substantially the same rotation angle.

The light receiving unit 41 has a receiver lens unit 42 and a light receiving unit 45. As shown in FIG. 1, the receiver lens unit 42 is configured such that at least one light receiving lens 43 is held by a lens barrel 44. At least one light receiver lens 43 is mainly made of a light transmitting base material such as resin or glass, and is formed into a lens shape according to an optical function to be demonstrated. The light receiving lens 43 exerts an optical effect such that it forms an image of the reflected echo Er from the scanning mirror 32 onto the light receiving unit 45. The light receiver lens 43 is positioned in the lens barrel 44 with a light shielding property, formed, for example, of metal or resin. The receiver lens unit 42 with such a configuration is aligned with the light receiving unit 45, and forms a light-receiving axis for guiding the reflected echo Er from the scanning unit 31 to the unit 45, offset in the vertical direction from the projection optical axis of the projection lens unit 26.

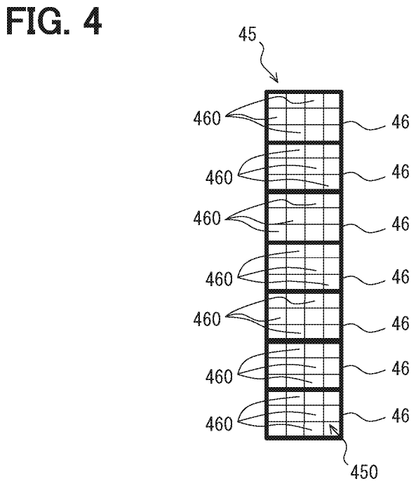

As shown in FIG. 4, the light receiving unit 45 is constructed by arranging light-receiving pixels 46 on a substrate 450 in an arrayed manner. Each light-receiving pixel 46 is arranged at least along the vertical direction. The light receiving unit 45 has a light receiving surface 450 with a rectangular contour that is elongated in the vertical direction and shortened in the horizontal direction, formed on one side of the substrate. The light-receiving surface 450 is configured as a collection of incident surfaces of each light-receiving pixel 46. Each light-receiving pixel 46 is composed of light-receiving elements 460, for example, single photon avalanche diodes (SPADs) or the like. Each such light-receiving pixel 46 receives the reflected echo Er that has entered the light-receiving surface 450 from the light-receiving lens unit 42, as shown in FIG. 1.

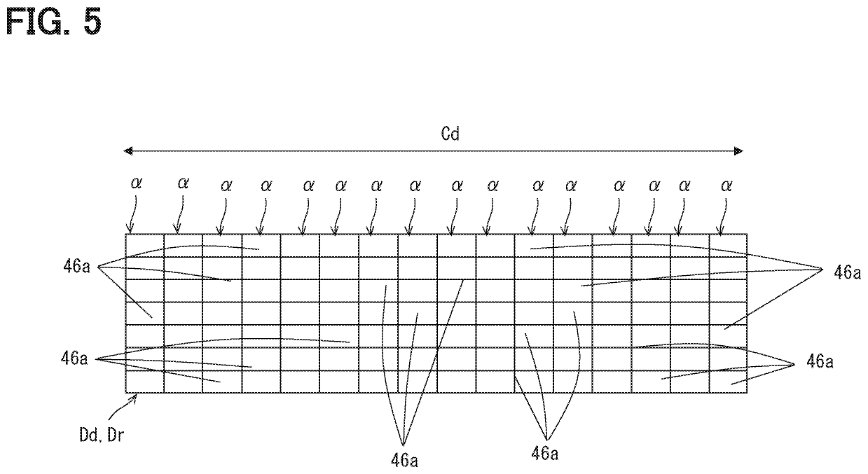

As shown in FIGS. 1 and 2, an output circuit 47 is provided in the light receiving unit 45. The output circuit 47 executes sampling processing for each scanning line according to the rotation angle of the scanning mirror 32 synchronized with the emission timing of the projected beam Bp from the light source unit 22, for each detection cycle Cd (see FIG. 5, described later), in accordance with the control signal from the controller 51. At this time, the output circuit 47 generates a detection signal by combining the response outputs from the light-receiving elements 460 of each light-receiving pixel 46 for each detection cycle Cd. The detection signal thus generated is output from the output circuit 47 to the controller 51 by each scanning line.

The controller 51 is composed of a controller mounted on the substrate, which includes at least one dedicated computer. The dedicated computer constituting the controller as the controller 51 may be a sensor ECU (Electronic Control Unit) specialized for controlling the optical sensor 10. In this case, the sensor ECU is housed within the housing 11 (see example in FIG. 1). The dedicated computer constituting the controller as the controller 51 may also be a driving control ECU specialized for controlling the operation of the moving object 1. In this case, the driving control ECU is disposed outside the housing 11 in the moving object 1 (not shown in the figures).

As shown in FIG. 1, the dedicated computer constituting the controller as the controller 51 includes at least one memory 51a and at least one processor 51b. The memory 51a is at least one type of non-transitory tangible storage medium out of, for example, a semiconductor memory, a magnetic medium, an optical medium, and the like that non-transitorily store a computer readable program, data, and the like. For example, the processor 51b may include, as a core, at least one of a central processing unit (CPU), a graphics processing unit (GPU), a reduced instruction set computer (RISC) CPU, a data flow processor (DFP), a graph streaming processor (GSP).

The controller 51 having such a configuration is connected to the light source unit 22, the scanning motor 35, and the light-receiving unit 45. The controller 51 controls the light source unit 22 to generate the projected beam in each detection cycle Cd. Along with this, the controller 51 controls the scanning motor 35 so as to control the scanning and reflection by the scanning mirror 32 in synchronization with the light emission timing of the light source unit 22, for each detection cycle Cd. Furthermore, the controller 51 processes, in each detection cycle Cd, the detection signal output from the output circuit 47 of the light-receiving unit 45, which is controlled in accordance with the light emission by the light source unit 22 and the scanning and reflection by the scanning mirror 32.

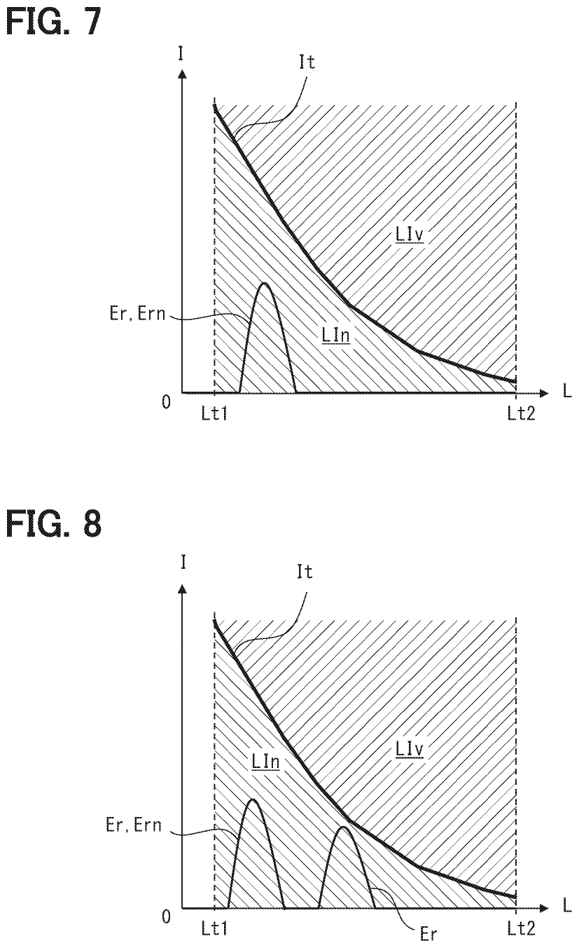

Through these operations, the controller 51 is able to generate the detection data Dd shown in FIG. 5, which represents, for each detection cycle Cd, a detection distance L to the target object Ot in the detection area Ad, as well as the received light intensity I of the reflected echo Er from the same target object Ot (see FIGS. 7-10 described later for “L” and “I”), and output this data to the moving object 1. At this time, in the detection data Dd, even if the detection distance L and the received light intensity I are physically detected by the same light-receiving pixel 46, as shown in FIG. 5, they are reflected as data values associated with different detection pixels 46a among different scan lines a within the detection cycle Cd.

To specifically implement such control, the processor 51b executes instructions included in a control program stored in the memory 51a. As a result, the controller 51 constructs functional blocks for controlling the optical sensor 10. As shown in FIG. 2, the functional blocks constructed by the controller 51 include a detection block 100, a monitoring block 110, and a data generation block 120.

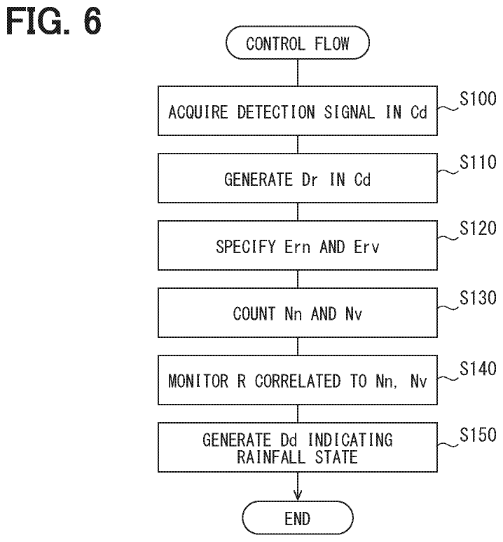

Through the cooperation of these blocks 100, 110, and 120, the control method by which the controller 51 controls the optical sensor 10 is executed according to a control flow shown in FIG. 6. This control flow is repeatedly executed for each detection cycle Cd during the activation of the moving object 1. It should be noted that each “S” in the control flow represents a respective step that is executed by a plurality of instructions included in the control program.

In S100, the detection block 100 acquires detection signals for each scan line a in the current detection cycle Cd from the output circuit 47. Subsequently, in S110, the detection block 100 generates light reception data Dr (see FIG. 5) for all the detection pixels 46a in the light receiving unit 45, based on the detection signals for each scan line a acquired in the current detection cycle Cd.

More specifically, in S110, the detection distance L to the target object Ot is obtained according to the elapsed time from the emission timing of the projected beam Bp by the light source unit 22 to the timing at which the light receiving unit 45 receives the peak of the reflected echo Er. The obtained detection distance L is associated with each detection pixel 46a, in accordance with the detection data Dd, as the data value of the light reception data Dr used for generating the detection data Dd, which will be described later. At the same time, in S110, the received light intensity I at the peak of the reflected echo Er received by the light receiving unit 45 is also acquired and is associated with each detection pixel 46a as a data value of the light reception data Dr. At this time, the received light intensity I of the reflected echo Er may be corrected by subtracting the estimated background light intensity, which is estimated, for example, based on the received light intensity I associated with detection pixels 46a where the peak of the reflected echo Er is not detected. As a result, in the light reception data Dr, both the detection distance L and the received light intensity I are mutually associated for each detection pixel 46a.

In the subsequent S120, the monitoring block 110 specifies the type of reflected echo Er detected for each detection pixel 46a from the light reception data Dr generated in the current detection cycle Cd. The types of reflected echo Er that are specified include, as shown in FIGS. 7 to 9, noise echo Ern and valid echo Erv. Therefore, in order to specifically identify the noise echo Ern and the valid echo Erv, a noise range Lin and a valid range Liv are defined, respectively.

More specifically, as shown in FIGS. 7 to 10, the noise range LIn and the valid range LIv are defined with respect to the received light intensity I, with a threshold intensity It corresponding to the detection distance L serving as an upper boundary for one and a lower boundary for the other, respectively. The threshold intensity It is set to decrease monotonically as the detection distance L increases. It is preferable that, as exemplified in FIGS. 7 to 10, the threshold intensity It decreases at a gradually lower rate per unit distance as the detection distance L increases.

Furthermore, as shown in FIGS. 7 to 10, the noise range LIn and the valid range LIv are defined, with respect to the detection distance L, within a range that is equal to or greater than a first value Lt1 and equal to or less than a second value Lt2. The first value Lt1 is set, for example, to exceed zero within a range of a separation distance between the detection surface 12a and the light receiving surface 450, so as to correspond to a position of the detection surface 12a in the optical sensor 10. The second value Lt2 is set so as to correspond to the detection limit distance of the optical sensor 10, for example, to a separation distance between a far point of the depth of field provided by the receiver lens unit 42 and the detection surface 12a.

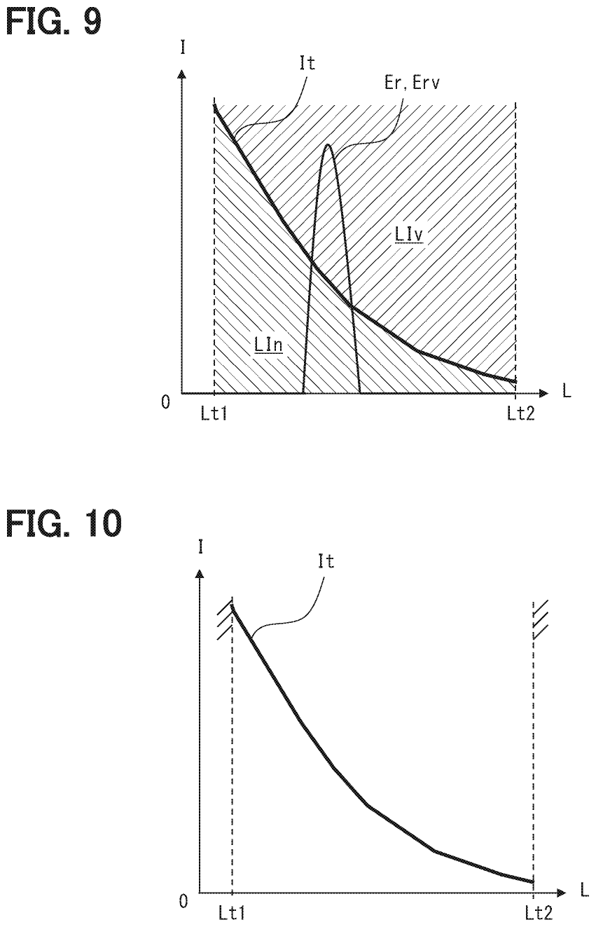

With such definitions and settings, the noise range Lin becomes a conditional range for identifying noise echoes Ern, in which the received light intensity I is equal to or less than the upper boundary threshold intensity It, from among the reflected echoes Er at detection distances L that are equal to or greater than the first value Lt1 and equal to or less than the second value Lt2, as shown in FIGS. 7 and 8. As a result, even if the received light intensity I of a reflected echo Er is equal to or less than the threshold intensity It, any reflected echo Er at a detection distance L that is less than the first value Lt1 or exceeds the second value Lt2 is excluded from being identified as a noise echo Ern. On the other hand, the valid range Liv serves as a conditional range for identifying valid echoes Erv, in which the received light intensity I exceeds the lower boundary threshold intensity It, from among the reflected echoes Er at detection distances L that are equal to or greater than the first value Lt1 and equal to or less than the second value Lt2, as shown in FIG. 9. As a result, even if the received light intensity I of a reflected echo Er exceeds the threshold intensity It, any reflected echo Er at a detection distance L that is less than the first value Lt1 or exceeds the second value Lt2 is excluded from being identified as an effective echo Erv.

It should be noted that, in the examples shown in FIGS. 7 to 10, the first value Lt1 is set to a common value for both the noise range LIn and the valid range LIv. However, it is also possible to set different values for the noise range LIn and the valid range LIv. The second value Lt2, in the examples shown in FIGS. 7 to 10, is set to a common value for both the noise range LIn and the valid range LIv/However, it may also be set to different values for the noise range LIn and the valid range LIv. With respect to the received light intensity I, the noise range LIn, which is below the threshold intensity It, and the valid range LIv, which is at or above the threshold intensity It, may be applied to detection distances L that are equal to or greater than the first value Lt1 and equal to or less than the second value Lt2.

In S120 of FIG. 6, for each detection pixel 46a, a reflected echo Er in which the detection distance L and the received light intensity I are associated within the noise range Lin is identified as a noise echo Ern. At this time, in the first embodiment, among the reflected echoes Er whose light reception timing is the earliest in the current detection cycle Cd for each detection pixel 46a, as shown in FIGS. 7 and 8, the noise echo Ern is identified by limiting the reflected echoes Er to those in which the detection distance L and the received light intensity I are within the noise range Lin. Here, a fact that the light reception timing is the earliest is equivalent to the detection distance L, which yields the received light intensity I within the noise range Lin for each detection pixel 46a, being the shortest in the current detection cycle Cd. The noise echo Ern identified in this manner is defined as a reflected echo Er from raindrops falling in the external environment, distinguished from the reflected echo Er from the actual detection target object Ot.

On the other hand, in S120, for each detection pixel 46a, a reflected echo Er in which the detection distance L and the received light intensity I are associated within the valid range Liv is identified as a valid echo Erv. At this time, in the first embodiment, among the reflected echoes Er whose light reception timing is the earliest in the current detection cycle Cd for each detection pixel 46a, as shown in FIG. 9, the valid echo Erv is identified by limiting the reflected echoes Er to those in which the detection distance L and the received light intensity I are within the valid range LIv. Here, the fact that the light reception timing is the earliest is equivalent to the detection distance L, which yields the received light intensity I within the valid range LIv for each detection pixel 46a, being the shortest in the current detection cycle Cd. The valid echo Erv identified in this manner is defined as the reflected echo Er from the target object Ot, excluding raindrops.

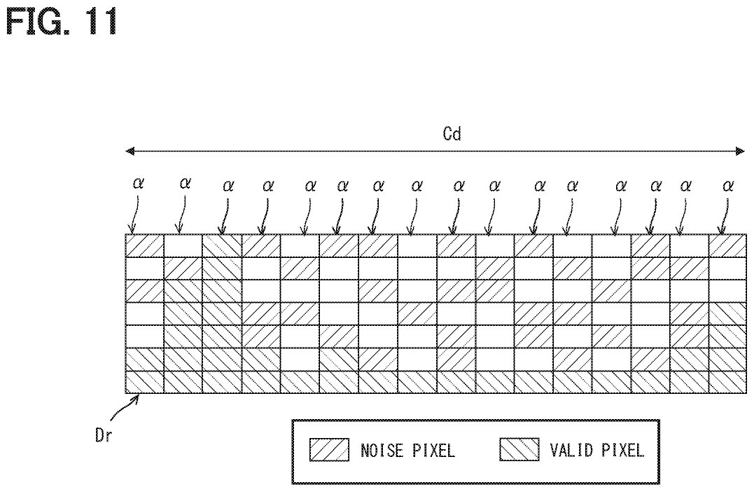

As shown in FIG. 6, in the subsequent S130, the monitoring block 110 extracts, for the current detection cycle Cd, the number of noise pixels as shown in FIG. 11, corresponding to the detection pixels 46a for which noise echoes Ern were identified in S120. That is, in S130 of FIG. 6, the noise pixel count Nn, which is the number of noise pixels that detected noise echoes Ern in the current detection cycle Cd, is counted. Along with that, in S130, the monitoring block 110 extracts, for the current detection cycle Cd, the valid pixel count as shown in FIG. 11, corresponding to the detection pixels 46a for which valid echoes Erv were identified in S120. That is, in S130 of FIG. 6, the valid pixel count Nv, which is the valid pixel count that detected valid echoes Erv in the current detection cycle Cd, is also counted.

As shown in FIG. 6, in the subsequent S140, the monitoring block 110 monitors a noise ratio R, which correlates with a noise pixel count Nn and the valid pixel count Nv counted in S130 for the current detection cycle Cd. At this time, the noise ratio R is defined, according to Equation 1 below, as a proportion of the noise pixel count Nn to the corrected pixel count, which is obtained by subtracting the valid pixel count Nv from the total number ΣN of detection pixels 46a. Here, in particular, as described above, in the first embodiment where the earliest reflected echo Er is limited to the noise echo Ern, the noise pixel count Nn substantially coincides with the number of noise echoes Ern. As a result, the noise ratio R in the first embodiment becomes equivalent to the ratio of the number of noise echoes Ern to the corrected pixel count, which is obtained by subtracting the valid pixel count Nv from the total number ΣN of detection pixels 46a.

$$\begin{matrix}[ Equation 1 ] & \\ R = \frac{Nn}{\sum N - Nv} & ( 1 )\end{matrix}$$

At this time, in the monitoring of S140, each of the noise pixel count Nn and the valid pixel count Nv may be used, limited to their values in the current detection cycle Cd. For the monitoring of S140, as each of the noise pixel count Nn and the valid pixel count Nv, in addition to the values from the current detection cycle Cd, an average value may be used, obtained by accumulating and then averaging the values from a set number of past detection cycles Cd. Here, when the latter average value is used, the preset number of past cycles to be added to the current cycle may be, for example, set to the most recent nine past cycles, so that the total values for the current and past cycles amount to ten cycles to be averaged.

As shown in FIG. 6, in the subsequent S150, the data generation block 120 generates detection data Dd, which is output to the moving object 1. This detection data Dd includes the received light data Dr for all detection pixels 46a and, according to the noise ratio R monitored in S140, provides notification of the external rainfall condition. At this time, the rainfall condition may be output as diagnostic information by the detection data Dd, as the rainfall amount Q per set time, which is defined according to the following Equation 2 using a function F, which may be a monomial or polynomial, of the noise ratio R as a physical quantity correlated with rainfall. The rainfall condition may also be output by the detection data Dd as warning information indicating heavy rainfall, in response to the noise ratio R rising to within a warning range at or above the noise threshold. Here, it is preferable that the warning range is preset to a range of noise ratio R corresponding to an amount of rainfall at which it is necessary to issue a warning to the moving object 1 equipped with the optical sensor 10.

[Equation 2]

Q=F(R) (2)

Thus, while the moving object 1 is in operation, when the current execution of the control flow in the present detection cycle Cd ends upon completion of S150, the next execution of the control flow for the subsequent detection cycle Cd is started.

### Actions and Effects

The actions and the effects of the first embodiment described above are described below.

In the first embodiment, for the detection distance L to the target object Ot corresponding to the reception timing of the reflected echo Er by the optical sensor 10, the received light intensity I of the reflected echo Er by the optical sensor 10 is associated with each detection pixel 46a of the detection data Dd and acquired for each detection cycle Cd. Accordingly, in the first embodiment, attention is focused on the corrected number of pixels obtained by subtracting and correcting the valid pixel count Nv from the total number ΣN of detection pixels 46a. The detection pixels 46a have detected a valid echo Erv identified as the reflected echo Er from the target Ot.

More specifically, according to the first embodiment, a corrected pixel count is a number of detection pixels 46a in which a reflected echo Er from a target Ot is not detected. In each detection cycle Cd, the noise ratio R is monitored. The noise ratio R represents a proportion of noise pixels Nn that detect noise echoes Ern. The noise echoes Ern are identified as reflected echoes Er from raindrops fallen in an external environment. Here, in the first embodiment, it can be said that the noise ratio R is also monitored as the proportion of noise echoes Ern to the corrected pixel count. With such monitoring, it is possible to generate detection data Dd that notifies a rainfall condition according to the noise ratio R. The noise ratio R has been corrected for an influence of undetected noise echoes Ern from raindrops. The undetected noise echoes Ern occur due to detection of valid echoes Erv from the target Ot. Therefore, the optical sensor 10 that detects the distance L can be effectively utilized for accurate output of the rainfall condition based on the detection data Dd.

According to the first embodiment, reflected echoes Er are identified as noise echoes Ern within the noise range Lin. The noise range Lin is bounded by a threshold intensity It with respect to a received light intensity I. The threshold intensity It decreases as a detected distance L increases. Each reflected echo Er is associated with a detected distance L and a received light intensity I for each detection pixel 46a. As a result, it is possible to accurately distinguish noise echoes Ern originating from raindrops falling in the external environment from among the reflected echoes Er for each detection pixel 46a. On the other hand, the reflected echoes Er are identified as valid echoes Erv within the valid range Liv. The valid range Liv is bounded by a threshold intensity It that serves as a lower limit with respect to a received light intensity I. Each reflected echo Er is associated with a detected distance L and a received light intensity I for each detection pixel 46a. As a result, it is possible to accurately distinguish valid echoes Erv originating from the target object Ot from among the reflected echoes Er for each detection pixel 46a. Based on the above, by monitoring the noise ratio R, in which the identification results of the accurately distinguished noise echoes Ern and the valid echoes Erv can be reflected, it becomes possible to improve the output accuracy of the rainfall condition corresponding to the noise ratio R.

According to the first embodiment, among the reflected echoes Er for which the light reception timing is the earliest in each detection cycle Cd for each detection pixel 46a, those reflected echoes Er whose detection distance L and received light intensity I fall within the noise range Lin are identified as noise echoes Ern. On the other hand, among the reflected echoes Er with the earliest light reception timing in each detection cycle Cd for each detection pixel 46a, those reflected echoes Er whose detection distance L and received light intensity I fall within the valid range Liv are identified as valid echoes Erv. Based on the identification of these noise echoes Ern and valid echoes Erv, it is possible to accelerate the processor 51b's recognition of the noise pixel count Nn and the valid pixel count Nv corresponding to each echo, thereby shortening the generation time of detection data Dd for outputting the rainfall condition according to the noise ratio R.

According to the first embodiment, among the reflected echoes Er whose detection distance L and the received light intensity I fall within the noise range Lin, only those reflected echoes Er with the earliest light reception timing in each detection cycle Cd for each detection pixel 46a are identified as noise echoes Ern. As a result, since the processing by the processor 51b from the identification of noise echoes Ern to the determination of the noise pixel count Nn can be accelerated, the time required to generate detection data Dd for outputting the rainfall condition according to the noise ratio R can be further reduced.

According to the first embodiment, the noise echoes Ern and the valid echoes Erv are identified from the reflected echoes Er with a detection distance L equal to or greater than the first value Lt1, which corresponds to the position of the detection surface 12a exposed to the external environment in the optical sensor 10. In contrast, the reflected echoes Er with a detection distance L less than the first value Lt1 are excluded from the identification of the noise echoes Ern and the valid echoes Erv. As a result, the reflected echoes Er caused by factors other than raindrops, such as obstacles or dirt on the detection surface 12a, can be excluded, enabling accurate identification of the noise echoes Ern and the valid echoes Erv. Therefore, by monitoring the noise ratio R, which can reflect such accurate identification results, it is possible to improve the output accuracy of the rainfall condition according to the noise ratio R.

According to the first embodiment, the detection data Dd may be generated so as to notify the rainfall amount Q, which correlates with the noise ratio R, as the rainfall condition. In this case, it becomes possible to output the rainfall condition more precisely using the index of rainfall amount Q.

According to the first embodiment, the detection data Dd may be generated so as to notify the rainfall condition in response to an increase in the noise ratio R, up to a warning range for warning the moving object 1 on which the optical sensor 10 is mounted. In this case, the optical sensor 10 can be effectively utilized not only for the accurate output of the rainfall condition corresponding to the noise ratio R within the warning range, but also for ensuring safety during the movement of the moving object 1.

### Second Embodiment

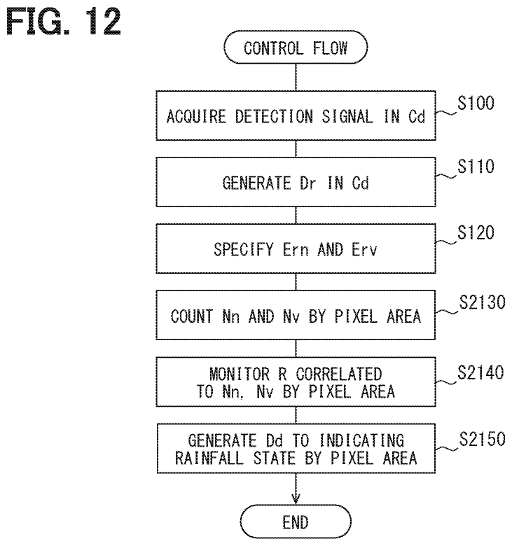

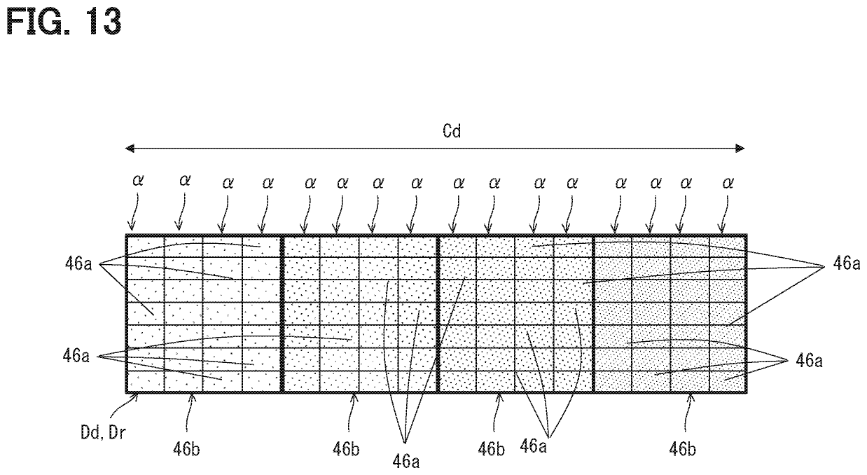

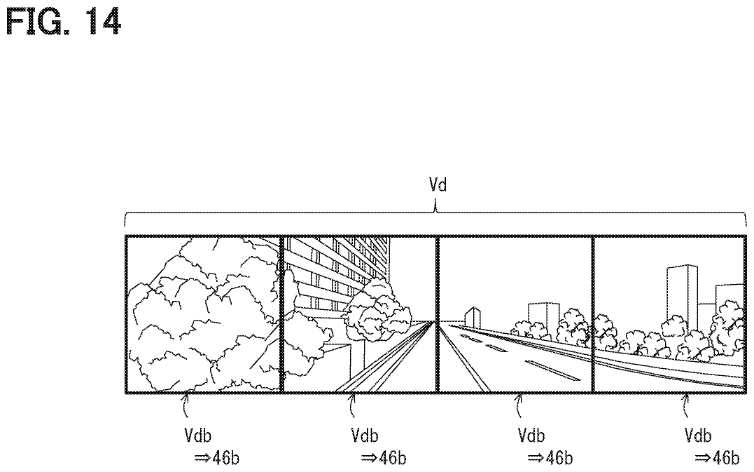

A second embodiment is a modification to the first embodiment. As shown in FIG. 12, in a control flow of the second embodiment, S2130, S2140, and S2150, which respectively correspond to S130, S140, and S150 of the first embodiment, are executed individually for each of the pixel areas 46b. Here, each pixel area 46b is defined by including a set number of detection pixels 46a, as indicated by dot hatching of varying density in FIG. 13. In this way, each pixel area 46b corresponds to a divided segment Vdb, which represents a partition of an entire detection field Vd covered by all the scanning lines a of the optical sensor 10, as shown in FIG. 14.

More specifically, in S2130, the monitoring block 110 counts the number of pixels Nn and Nv for each pixel area 46b. Therefore, in S2140, the monitoring block 110 monitors the noise ratio R for each pixel area 46b. Furthermore, in S2150, the data generation block 120 generates detection data Dd, which includes the received light data Dr for all detection pixels 46a and provides notification of the rainfall status according to the noise ratio R for each pixel area 46b. Thus, while the moving object 1 is in operation, when the current execution of the control flow in the present detection cycle Cd ends upon completion of S2150, the next execution of the control flow for the subsequent detection cycle Cd is started.

According to this second embodiment, since the noise ratio R is monitored for each pixel area 46b, which is defined to include a set number of detection pixels 46a, the rainfall status for each divided section Vdb of the detection field of view Vd corresponding to each pixel area 46b can be output by the detection data Dd. As a result, even for a relatively wide detection field of view Vd, it becomes possible to accurately notify the rainfall status for each divided section Vdb.

### Third Embodiment

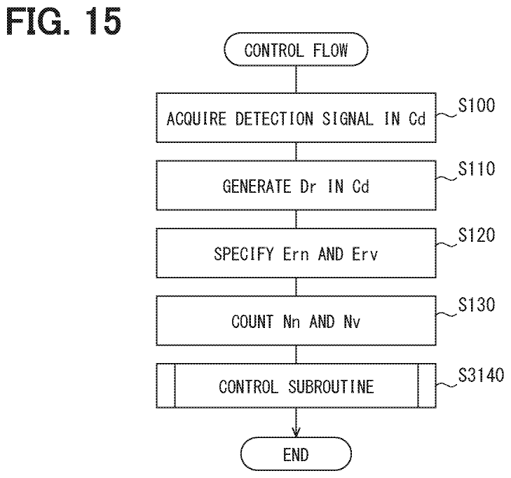

A third embodiment is a modification to the first embodiment. As shown in FIG. 15, in a control flow of the third embodiment, S3140 is executed in place of S140 and S150 of the first embodiment.

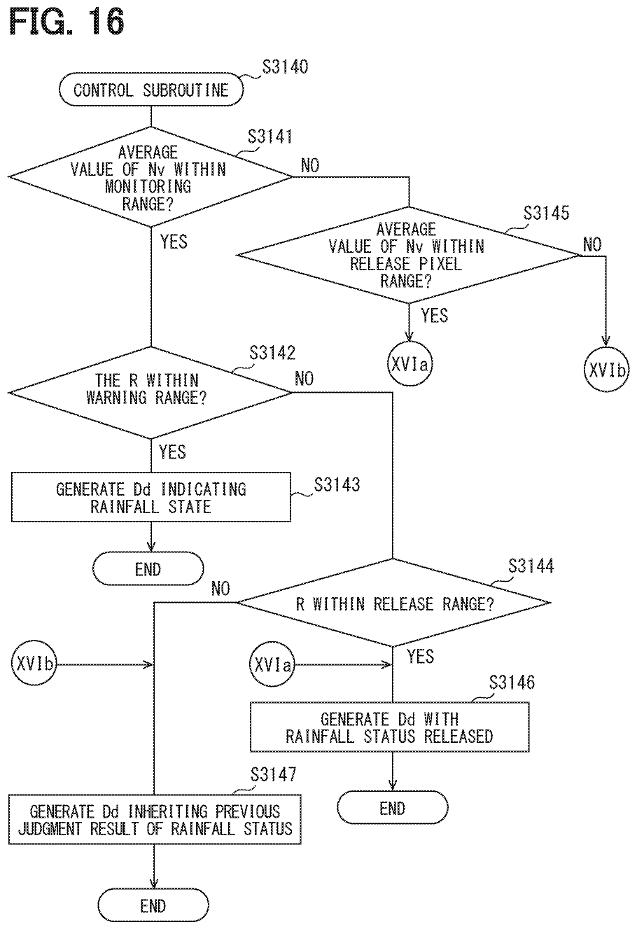

More specifically, in S3140, a control subroutine shown in FIG. 16 is executed. In S3141 of this control subroutine, the monitoring block 110 extracts an average value of the valid pixel count Nv for the current detection cycle Cd by adding the value counted by S130 for the current cycle to the values counted by S130 for the set number of past detection cycles, integrating them, and then averaging the result. Here, regarding the extraction of the valid pixel count Nv, the number of past cycles to be added to the current value is preferably preset, for example, to the most recent nine cycles so that a total of ten values including the current and past cycles are averaged.

In such S3141, the monitoring block 110 determines whether the average value of the valid pixel count Nv for the current and past cycles has decreased to within the monitoring range, which is at or below (or less than) the first effective threshold. Here, the monitoring range is preferably preset to the range of the valid pixel count Nv in which monitoring of the noise ratio R becomes necessary due to a decrease in Nv caused by rainfall conditions. When an affirmative determination is made by S3141, the control subroutine proceeds to S3142.

In S3142, the monitoring block 110 monitors the noise ratio R, which correlates with the noise pixel count Nn and the valid pixel count Nv, in accordance with Equation 1 of the first embodiment. That is, in S3142, the noise ratio R, which correlates with the valid pixel count Nv when it has decreased to within the monitoring range, is monitored. However, at this time, the average value is used as the value of the valid pixel count Nv, as in S3141. On the other hand, for the value of the noise pixel count Nn, the average value is used, which is obtained by integrating and then averaging the value counted by S130 in the current detection cycle Cd together with the values counted by S130 in the detection cycles Cd for a set number of past occurrences. Here, regarding the extraction of the noise pixel count Nn, the number of past occurrences to be added to the current count is preferably preset to, for example, the most recent nine occurrences so that the total number of current and past values averaged is ten.

In such S3142, the monitoring block 110 determines whether the monitored noise ratio R, based on the average values of the number of pixels Nn and Nv in the current and past cycles, has increased to within the warning range, that is, at or above the first noise threshold. Here, it is preferable that the warning range is preset to a range of noise ratio R corresponding to the amount of rainfall at which it is necessary to issue a warning to the moving object 1 on which the optical sensor 10 is mounted. When an affirmative determination is made in S3142, the control subroutine proceeds to S3143.

In S3143, the data generation block 120 generates detection data Dd, which includes the received light data Dr for all detection pixels 46a and, in accordance with the noise ratio R monitored in S3142, reports the external rainfall condition. At this time, the rainfall condition is output as warning information indicating heavy rainfall by the detection data Dd, in response to the noise ratio R increasing to within the warning range at or above the first noise threshold.

When a negative determination is made in S3142 above, the control subroutine proceeds to S3144. In S3144, the monitoring block 110 determines whether the monitored noise ratio R, based on the average values of the pixel counts Nn and Nv for the current and previous cycles as in S3142, has decreased to within a release range at or below the second noise threshold. Here, the release range is a range of noise ratio R corresponding to a rainfall amount at which the warning to the moving object 1 can be cancelled, and is preferably preset to a range of noise ratio R smaller than the warning range.

Also, when a negative determination is made in S3141 above, the control subroutine proceeds to S3145. In S3145, the monitoring block 110 determines whether the average value of the valid pixel count Nv extracted for the current and previous cycles, as in S3141, has increased to within a release pixel count range that is at or above the second valid threshold. Here, the release pixel count range is a range of valid pixel counts Nv corresponding to a rainfall amount at which the warning to the moving object 1 can be cancelled, and is preferably preset to a range of valid pixel counts Nv greater than the monitoring range.

When an affirmative determination is made in either S3144 or S4145, the control subroutine proceeds to S3146. In S3146, the data generation block 120 generates detection data Dd, which includes the light-receiving data Dr for all detection pixels 46a and is output so as to cancel the notification of the rainfall condition.

On the other hand, when a negative determination is made in either S3144 or S4145, the control subroutine proceeds to S3147. In S3147, the data generation block 120 generates detection data Dd, which includes the light-receiving data Dr for all detection pixels 46a and is output so as to inherit the notification or cancellation determination result regarding the rainfall condition from the previous detection cycle Cd, as determined in any of S3143, S3146, or S3147. Here, specifically, the determination result regarding the rainfall condition in S3147 of the previous detection cycle Cd inherits the notification or cancellation determination result from the detection cycle Cd in which either S3143 or S3146 was last executed in any cycle prior to the previous one.

Thus, while the moving object 1 is operating, once the current execution of the control flow and the control subroutine in the present detection cycle Cd is completed by the execution of any one of S3143, S3146, or S3147, the next execution of the control flow in the subsequent detection cycle Cd will be initiated.

According to the third embodiment described above, the detection data Dd is generated so as to notify the rainfall condition in response to an increase in the noise ratio R, up to within the warning range for warning the moving object 1 equipped with the optical sensor 10. Accordingly, not only can the rainfall condition be accurately output in accordance with the noise ratio R within the warning range, but the optical sensor 10 can also be effectively utilized to ensure safety during movement of the moving object 1.

Furthermore, according to the third embodiment, the noise ratio R, which correlates with the valid pixel count Nv (specifically, its average value) when it decreases within the monitoring range, is monitored. Accordingly, while the valid pixel count Nv remains high outside the monitoring range, it can be estimated that the noise pixel count Nn corresponding to rainfall is low. Therefore, the noise ratio R can be immediately determined to have decreased outside the warning range, even without monitoring. Therefore, it becomes possible to shorten the generation time of the detection data Dd in cases where the determination of the rainfall condition based on the noise ratio R is essentially unnecessary.

### Fourth Embodiment

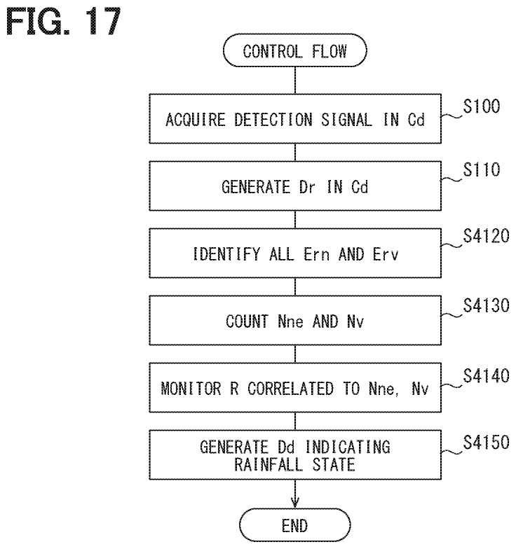

A fourth embodiment is a modification of the first embodiment. As shown in FIG. 17, in a control flow of the fourth embodiment, steps S4120, S4130, S4140, and S4150 are executed in place of steps S120, S130, S140, and S150, respectively, of the first embodiment.

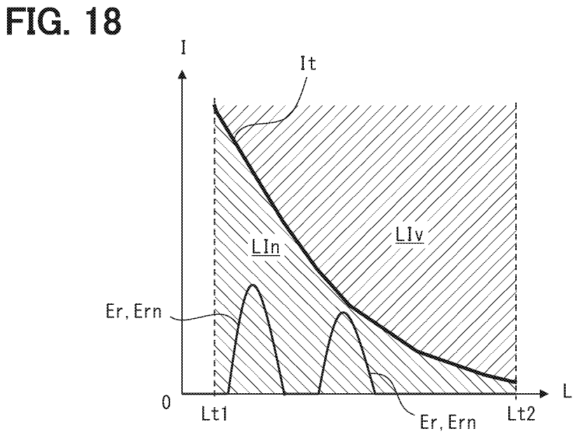

More specifically, in S4120, as shown in FIG. 18, the monitoring block 110 identifies, for each detection pixel 46a, all reflected echoes Er detected in the current detection cycle Cd as noise echoes Ern, among the reflected echoes Er for which the detection distance L and the received light intensity I fall within the noise range Lin and which share the same detection cycle Cd. That is, if the received light intensity I falls within the noise range Lin, not only the earliest reflected echo Er in the current detection cycle Cd for each detection pixel 46a, but also the second and subsequent reflected echoes Er detected in the same detection cycle Cd for each detection pixel 46a, are identified as distinct noise echoes Ern. Here, a fact that the received light timing is the second or later means that, for each detection pixel 46a, the detection distance L that yields a received light intensity I within the noise range Lin is the second shortest or later in the current detection cycle Cd; this is equivalent. However, the identification of valid echoes Erv in S4120 is performed in accordance with S120 of the first embodiment.

In such the fourth embodiment, in the subsequent S4130, as shown in FIG. 17, the monitoring block 110 counts, as the noise identification number Nne in place of the noise pixel count Nn, the total number of identified noise echoes Ern for each detection pixel 46a that has detected at least one noise echo Ern in the current detection cycle Cd. However, the counting of the valid pixel count Nv in S4130 is performed in accordance with S130 of the first embodiment.

In the subsequent S4140, the monitoring block 110 monitors the noise ratio R, which correlates with the noise identification number Nne and the valid pixel count Nv counted in S4130 for the current detection cycle Cd. At this time, the noise ratio R is defined, according to the following Equation 3, as the proportion of the noise identification number Nne to the corrected pixel count, which is obtained by subtracting the valid pixel count Nv from the total number ΣN of detection pixels 46a.

$$\begin{matrix}[ Equation 3 ] & \\ R = \frac{Nne}{\sum N - Nv} & ( 3 )\end{matrix}$$

Furthermore, in the subsequent S4150, the data generation block 120 generates detection data Dd that includes the received light data Dr for all detection pixels 46a and, in accordance with the noise ratio R monitored in S4140, notifies the external environment of the rainfall condition. At this time, the rainfall condition, as a physical quantity correlated with the noise ratio R, may be output by the detection data Dd as diagnostic information indicating the amount of rainfall Q per set time, which is defined according to the following Equation 4 using a function G of a different monomial or polynomial from Equation 2 of the first embodiment. However, as in S150 of the first embodiment, the rainfall condition may also be output as warning information notifying of heavy rainfall.

[Equation 4]

Q=G(R) (4)

Thus, while the moving object 1 is in operation, when the current execution of the control flow in the present detection cycle Cd ends upon completion of S4150, the next execution of the control flow for the subsequent detection cycle Cd is started.

In this way, the fourth embodiment also focuses on a corrected number of pixels. The corrected number of pixels is obtained by subtracting and adjusting the valid pixel count Nv from the total number ΣN of detection pixels 46a. The effective pixels Nv are detection pixels 46a that have detected an effective echo Erv. The effective echo Erv is identified as a reflected echo Er from a target object Ot. However, according to the fourth embodiment, the noise ratio R is monitored in each detection cycle Cd. The noise ratio R is a ratio of a noise identification number Nne to a corrected number of pixels. The noise identification number Nne is a number of noise echoes Ern identified as reflected echoes Er from raindrops that have fallen in the external environment. The corrected number of pixels is a number of detection pixels 46a in which a reflected echo Er from a target object Ot is not detected. Accordingly, it is possible to generate detection data Dd that notifies the rainfall condition based on the noise ratio R, which has been corrected for the influence of undetected noise echoes Ern from raindrops due to the detection of valid echoes Erv from the target object Ot. Therefore, the optical sensor 10 that detects the distance L can be effectively utilized for accurate output of the rainfall condition based on the detection data Dd.

Moreover, according to the fourth embodiment, among the reflected echoes Er whose detection distance L and received light intensity I fall within the noise range Lin, all reflected echoes Er detected for each detection pixel 46a during the same detection cycle Cd are identified as noise echoes Ern. Accordingly, the noise echoes Ern reflected by raindrops at different detection distances L from the optical sensor 10 can all be individually identified for each detection pixel 46a and for each detection cycle Cd, and reflected in the noise ratio R. As a result, it becomes possible to improve the accuracy of rainfall condition output according to this noise ratio R.

### OTHER EMBODIMENTS

Although multiple embodiments have been described above, the present disclosure is not to be construed as being restricted to these embodiments, and can be applied to various embodiments and combinations without departing from the spirit of the present disclosure.

In a modification, the dedicated computer constituting the controller 51 may include at least one of a digital circuit and an analog circuit as a processor. Here, the digital circuit refers to at least one type among, for example, an ASIC (Application Specific Integrated Circuit), FPGA (Field Programmable Gate Array), SoC (System on a Chip), PGA (Programmable Gate Array), and CPLD (Complex Programmable Logic Device). Such digital circuits may also include a memory for storing programs.

In steps S150, S2150, S3143, S3146, S3147, and S4150 of the modification, the detection data Dd relating to the rainfall condition may be generated independently from the detection data Dd that includes the received light data Dr for all detection pixels 46a. In this case, the generation of separate detection data Dd including the received light data Dr for all detection pixels 46a may be carried out by the data generation block 120 in steps S150, S2150, S3143, S3146, S3147, and S4150, or may be carried out in advance by the detection block 100 or the data generation block 120 in step S110.

In the modification, the process in step S4120 of the fourth embodiment, in which all reflected echoes Er within the noise range Lin are identified as noise echoes Ern, may be executed in place of the process in step S120 of the first to third embodiments, in which only the earliest reflected echo Er within the noise range Lin is identified as a noise echo Ern. In this case, in steps S130 and S2130 of the first to third embodiments, it is preferable that the noise pixel count Nn, which is the number of detection pixels 46a that have detected at least one noise echo Ern in the current detection cycle Cd, be counted.

In the modification, the process of identifying all reflected echoes Er within the valid range Liv as valid echoes Erv, in accordance with step S4120 of the fourth embodiment, may be executed in place of the process in steps S120 and S4120 of the first to fourth embodiments, in which only the earliest reflected echo Er within the valid range Liv is identified as an effective echo Erv. In this case, in steps S130, S2130, and S4130 of the first to fourth embodiments, it is preferable that the valid pixel count Nv, which is the number of detection pixels 46a that have detected at least one effective echo Erv in the current detection cycle Cd, be counted.

In the modification, the execution for each pixel area 46b according to the second embodiment may be applied to the execution of steps S130 and S3140 in the third embodiment. In the modification, the execution for each pixel area 46b according to the second embodiment may be applied to the execution of steps S4130, S4140, and S4150 in the fourth embodiment. In the modification, the detection data Dd for notifying the rainfall amount Q according to number 2 in step S150 of the first embodiment may be executed instead of, or in addition to, the detection data Dd for notifying a large rainfall amount in response to the increase of the noise ratio R into the warning range in step S3143 of step S3140 of the third embodiment. In the modification, at least one of the ranges Lin and Liv may be defined as a range of detection distance L equal to or greater than zero, without setting the near-side threshold Lt1.

In the modification, the identification of noise echo Ern in step S4120 of the fourth embodiment may be executed instead of the identification of noise echo Ern in step S120 of the third embodiment. In this case, counting the number of identified noises Nne in step S4130 of the fourth embodiment is preferably executed instead of counting the noise pixel count Nn in step S130 of the third embodiment. Along with this, in this case, monitoring of the noise ratio R correlated with the number of identified noises Nne in step S4140 of the fourth embodiment is preferably executed instead of monitoring the noise ratio R correlated with the noise pixel count Nn in step S3142 of step S3140 of the third embodiment. Furthermore, in this case, the detection data Dd for notifying the rainfall amount Q according to Equation 4 in step S4150 of the fourth embodiment is preferably executed instead of, or in addition to, the detection data Dd for notifying a large rainfall amount in response to the noise ratio R rising within the warning range in step S3143 of step S3140 of the third embodiment.

In the modification, the moving object 1 to which the controller executing the above-mentioned control method and control program as the controller 51, as well as the optical sensor 10 equipped with the controller, are applied may be, for example, an autonomous mobile robot capable of tasks such as cargo transport or information collection through autonomous driving or remote driving. In the modification, the controller that executes the above-described control method and control program as the controller 51, as well as the optical sensor 10 equipped with it, may be applied not only to the moving object 1 but also to infrastructure facilities such as smart poles, for example. In addition to the embodiments described so far, each of the above-mentioned embodiments and modifications may be implemented in the form of a semiconductor device (for example, a semiconductor chip) as the controller serving as the controller 51.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A controller comprising:
at least one of (i) a circuit and (ii) a processor with a memory storing computer program code executable by the processor, wherein
the at least one of the circuit and the processor is configured to case the controller to:
control an optical sensor configured to, for each detection cycle, receive reflected echoes from an object in response to projected beams emitted to an external environment, and to output detection data;
acquire, for each detection cycle and for each detection pixel of the detection data, a received light intensity of each of the reflected echoes that is received by the optical sensor and associated with a detection distance to the object, the detection distance corresponding to a reception timing of the reflected echo by the optical sensor;
monitor a noise ratio for each detection cycle; and
generate, based on the noise ratio, the detection data indicating a rainfall condition in the external environment, wherein
the noise ratio is a ratio of a number of noise pixels to a corrected number of pixels,
the number of noise pixels is a number of detection pixels that have detected noise echoes identified as reflected echoes from raindrops falling in the external environment,
the corrected number of pixels is obtained by subtracting a number of valid pixels from a total number of detection pixels that have detected the reflected echoes, and
the number of valid pixels is a number of detection pixels that have detected valid echoes identified as reflected echoes from the object.

2. A controller comprising:
at least one of (i) a circuit and (ii) a processor with a memory storing computer program code executable by the processor, wherein
the at least one of the circuit and the processor is configured to case the controller to:
control an optical sensor configured to, for each detection cycle, receive reflected echoes from an object in response to projected beams emitted to an external environment, and to output detection data;
acquire, for each detection cycle and for each detection pixel of the detection data, a received light intensity of each of the reflected echoes that is received by the optical sensor and associated with a detection distance to the object, the detection distance corresponding to a reception timing of the reflected echo by the optical sensor;
monitor a noise ratio for each detection cycle; and
generate, based on the noise ratio, the detection data indicating a rainfall condition in the external environment, wherein
the noise ratio is a ratio of a number of noise echoes to a corrected number of pixels,
the noise echoes are identified as reflected echoes from raindrops falling in the external environment,
the corrected number of pixels is obtained by subtracting a number of valid pixels from a total number of detection pixels that have detected the reflected echoes, and
the number of valid pixels is a number of detection pixels that have detected valid echoes identified as reflected echoes from the object.

3. The controller according to claim 1, wherein
the at least one of the circuit and the processor is configured to case the controller to:
identify, as the noise echoes, reflected echoes whose detection distance and received light intensity associated with each other for each detection pixel are within a noise range, the noise range having an upper boundary defined by a threshold intensity that decreases as the detection distance increases;
identify, as the valid echoes, reflected echoes whose detection distance and received light intensity associated with each other for each detection pixel are within a valid range, the valid range having a lower boundary defined by the threshold intensity; and
monitor the noise ratio based on the identified noise echoes and the identified valid echoes for each detection cycle.

4. The controller according to claim 3, wherein
the at least one of the circuit and the processor is configured to case the controller to:
identify, as the noise echoes, the reflected echoes whose detection distance and received light intensity are within the noise range, among reflected echoes at an earliest reception timing in each detection cycle for each detection pixel;
identify, as the valid echoes, the reflected echoes whose detection distance and received light intensity are within the valid range, among the reflected echoes at an earliest reception timing in each detection cycle for each detection pixel; and
monitor the noise ratio based on the identified noise echoes and the identified valid echoes for each detection cycle.

5. The controller according to claim 4, wherein
the at least one of the circuit and the processor is configured to case the controller to:
identify, as the noise echoes, only the reflected echoes at the earliest reception timing in each detection cycle for each detection pixel, among the reflected echoes whose detection distance and received light intensity are within the noise range; and
monitor the noise ratio based on the identified noise echoes for each detection cycle.

6. The controller according to claim 4, wherein
the at least one of the circuit and the processor is configured to case the controller to:
identify, as the noise echoes, all of the reflected echoes detected in the same detection cycle for each detection pixel, among the reflected echoes whose detection distance and received light intensity are within the noise range; and
monitor the noise ratio based on the identified noise echoes for each detection cycle.

7. The controller according to claim 3, wherein
the at least one of the circuit and the processor is configured to case the controller to:
identify the noise echoes and the valid echoes among the reflected echoes having a detection distance equal to or greater than a threshold distance, the threshold distance corresponding to a position of a detection surface of the optical sensor exposed to the external environment;
exclude, from the identifying of the noise echoes and the valid echoes, the reflected echoes having a detection distance less than the threshold distance; and
monitor the noise ratio based on the identified noise echoes and the identified valid echoes for each detection cycle.

8. The controller according to claim 1, wherein
the at least one of the circuit and the processor is configured to case the controller to monitor the noise ratio for each pixel area defined to include a set number of the detection pixels.

9. The controller according to claim 1, wherein
the detection data further includes data to indicate, as the rainfall condition, an amount of rainfall correlated with the noise ratio.

10. The controller according to claim 1, wherein
the detection data further includes data to indicate the rainfall condition in response to the noise ratio increasing to within a warning range for warning a moving object on which the optical sensor is mounted.

11. The controller according to claim 10, wherein
the at least one of the circuit and the processor is configured to case the controller to monitor the noise ratio correlated with the number of the valid pixels when the number of the valid pixels has decreased to within a monitoring range.

12. An optical sensor configured to, for each detection cycle, receive reflected echoes from an object in response to projected beams emitted to an external environment, and output detection data, the optical sensor comprising:
the controller according to claim 1;
a light emitting unit configured to emit the projected beams in accordance with control by the controller; and
a light receiving unit configured to receive the reflected echoes in accordance with control by the controller.

13. A control method, executed by at least one of a circuit and a processor, to control an optical sensor configured to, for each detection cycle, receive reflected echoes from an object in response to projected beams emitted to an external environment, and output detection data, the control method comprising:
acquiring, for each detection cycle and for each detection pixel of the detection data, a received light intensity of each of the reflected echoes that is received by the optical sensor and associated with a detection distance to the object, the detection distance corresponding to a reception timing of the reflected echo by the optical sensor;
monitoring a noise ratio for each detection cycle; and
generating, based on the noise ratio, the detection data indicating a rainfall condition in the external environment, wherein
the noise ratio is a ratio of a number of noise pixels to a corrected number of pixels,
the number of noise pixels is a number of detection pixels that have detected noise echoes identified as reflected echoes from raindrops falling in the external environment,
the corrected number of pixels is obtained by subtracting a number of valid pixels from a total number of detection pixels that have detected the reflected echoes, and
the number of valid pixels is a number of detection pixels that have detected valid echoes identified as reflected echoes from the object.

14. A control method, executed by at least one of a circuit and a processor, to control an optical sensor configured to, for each detection cycle, receive reflected echoes from an object in response to projected beams emitted to an external environment, and output detection data, the control method comprising:
acquiring, for each detection cycle and for each detection pixel of the detection data, a received light intensity of each of the reflected echoes that is received by the optical sensor and associated with a detection distance to the object, the detection distance corresponding to a reception timing of the reflected echo by the optical sensor;
monitoring a noise ratio for each detection cycle; and
generating, based on the noise ratio, the detection data indicating a rainfall condition in the external environment, wherein
the noise ratio is a ratio of a number of noise echoes to a corrected number of pixels,
the noise echoes are identified as reflected echoes from raindrops falling in the external environment,
the corrected number of pixels is obtained by subtracting a number of valid pixels from a total number of detection pixels that have detected the reflected echoes, and
the number of valid pixels is the number of detection pixels that have detected valid echoes identified as reflected echoes from the object.

15. A non-transitory computer readable storage medium storing a program comprising instructions configured to, when executed by at least one processor, cause the at least one processor to:
control an optical sensor configured to, for each detection cycle, receive reflected echoes from an object in response to projected beams emitted to an external environment, and to output detection data;
acquire, for each detection cycle and for each detection pixel of the detection data, a received light intensity of each of the reflected echoes that is received by the optical sensor and associated with a detection distance to the object, the detection distance corresponding to a reception timing of the reflected echoes by the optical sensor;
monitor a noise ratio for each detection cycle; and
generate, based on the noise ratio, the detection data indicating a rainfall condition in the external environment, wherein
the noise ratio is a ratio of a number of noise pixels to a corrected number of pixels,
the number of noise pixels is a number of detection pixels that have detected noise echoes identified as reflected echoes from raindrops falling in the external environment,
the corrected number of pixels is obtained by subtracting a number of valid pixels from a total number of detection pixels that have detected the reflected echoes, and
the number of valid pixels is a number of detection pixels that have detected valid echoes identified as reflected echoes from the object.

16. A non-transitory computer readable storage medium storing a program comprising instructions configured to, when executed by at least one processor, cause the at least one processor to:
control an optical sensor configured to, for each detection cycle, receive reflected echoes from an object in response to projected beams emitted to an external environment, and to output detection data;
acquire, for each detection cycle and for each detection pixel of the detection data, a received light intensity of each of the reflected echoes that is received by the optical sensor and associated with a detection distance to the object, the detection distance corresponding to a reception timing of the reflected echoes by the optical sensor;
monitor a noise ratio for each detection cycle; and
generate, based on the noise ratio, the detection data indicating a rainfall condition in the external environment, wherein
the noise ratio is a ratio of a number of noise echoes to a corrected number of pixels,
the noise echoes are identified as reflected echoes from raindrops falling in the external environment,
the corrected number of pixels is obtained by subtracting a number of valid pixels from a total number of detection pixels that have detected the reflected echoes, and
the number of valid pixels is the number of detection pixels that have detected valid echoes identified as reflected echoes from the object.
